(19) United States
(12) Patent Application Publication
(10) Pub. No.: US 2011/0143817 A1
(43) Pub. Date: Jun. 16, 2011

(54) MOBILE DEVICE AND OPERATION ACCEPTING METHOD

(75) Inventors: Hiroko Asabu, Osaka (JP); Minako Tani, Osaka (JP)

(73) Assignee: KYOCERA CORPORATION, Kyoto (JP)

(21) Appl. No.: 13/056,016

(22) PCT Filed: Jul. 29, 2009
(86) PCT No.: PCT/JP2009/003575

§ 371 Date: Jan. 26, 2011

(30) Foreign Application Priority Data
Jul. 29, 2008 (JP) 2008-194982

(51) Int. Cl. H04M 1/02

(52) U.S. Cl. 455/566

(57) ABSTRACT

In order to facilitate an operation of a mobile phone in its closed state, the mobile phone changeable in state between an open state and a closed state includes a light emitting portion which emits light in a plurality of colors to the outside in the closed state, an association portion which associates a respective one of a plurality of types of processes with one of a plurality of colors, an acceleration detecting portion which accepts a shaking operation, a process selecting portion which selects one of the plurality of types of processes when the shaking operation is accepted, a light emission control portion which causes the light emitting portion to emit light in the color associated with the selected process in the closed state, and a process executing portion which executes the selected process upon detection of a change from the closed state to the open state.

### TECHNICAL FIELD

The present invention relates to a mobile device and an operation accepting method. More particularly, the present invention relates to a mobile device which can be changed in style between a closed state and an open state, and an operation accepting method performed in the mobile device.

### BACKGROUND ART

A mobile phone is provided with many functions, and has a plurality of operation screens hierarchically arranged to allow a user to select one of the functions to be performed. With the large number of functions available, a menu screen includes many options with a deep hierarchy, which requires the user's skill to display a desired operation screen. As a technique of facilitating the operations, an information display method for a mobile information terminal is known in which, in the case where operation menus having a hierarchical structure are to be displayed, in the operation menu in the highest hierarchical level, a plurality of display items representing a plurality of menu options are displayed on a display screen in different colors from each other, and in the operation menus in the lower hierarchical levels, the display items representing the menu options which are subordinate to any of the menu options configuring the operation menu in the highest hierarchical level are each displayed in the same color as that of the corresponding item in the operation menu in the highest hierarchical level.

Many mobile phones are configured to be changed in style, according to whether it is in use or not, in consideration of convenience of use and portability. This type of mobile phone is in a closed state with a low profile when not in use, while it is in an open state when in use. When the mobile phone is in the closed state, a display screen faces inward, hindering the user from operating the mobile phone while looking at an operation menu or other operation screen.

### DISCLOSURE OF THE INVENTION

### Problems to be Solved by the Invention

The present invention has been accomplished to solve the above-described problems, and an object of the present invention is to provide a mobile device which facilitates an operation in a closed state.

Another object of the present invention is to provide an operation accepting method which facilitates an operation of a mobile device in a closed state.

### Means for Solving the Problems

To achieve the above-described objects, according to an aspect of the present invention, a mobile device changeable in style between an open state and a closed state includes: light emitting means for emitting light in a plurality of colors toward the outside in the closed state; association means for associating a respective one of a plurality of types of processes with one of the plurality of colors; operation accepting means for accepting a predetermined operation; process selecting means for selecting one of the plurality of types of processes in response to an event that the predetermined operation is accepted; light emission control means for causing the light emitting means to emit light in the color that is associated with the selected process in the closed state; and process executing means for executing the selected process in response to an event that a change from the closed state to the open state is detected.

According to another aspect of the present invention, an operation accepting method is performed in a mobile device changeable in style between an open state and a closed state, the mobile device including light emitting means for emitting light in a plurality of colors toward the outside in the closed state, wherein the method includes the steps of: associating a respective one of a plurality of types of processes with one of the plurality of colors; accepting a predetermined operation; selecting one of the plurality of types of processes in response to an event that the predetermined operation is accepted; causing the light emitting means to emit light in the color that is associated with the selected process in the closed state; and executing the selected process in response to an event that a change from the closed state to the open state is detected.

### BRIEF DESCRIPTION OF THE DRAWINGS

FIG. 1A is a perspective view of a mobile phone in an open style according to an embodiment of the present invention.

FIG. 1B is a perspective view of the mobile phone in a closed style according to the embodiment of the present invention.

FIG. 2 is a plan view of a light emitting portion.

FIG. 3 is a functional block diagram showing an example of the functions of the mobile phone according to the present embodiment.

FIG. 4 is a functional block diagram schematically showing the functions of a control portion, together with data stored in an EEPROM.

FIG. 5 shows an example of a condition table.

FIG. 6A shows an example of a first-color record in a color table.

FIG. 6B shows an example of a second-color record in a color table.

FIG. 7 shows an example of a list displaying state of the light emitting portion.

FIG. 8 shows an example of a selection displaying state of the light emitting portion.

FIG. 9 is a flowchart illustrating an example of the flow of an operation accepting process.

FIG. 10 is a functional block diagram showing an example of the functions of the control portion included in the mobile phone according to a modification.

FIG. 11 shows an example of a third-color record according to the modification.

FIG. 12 is a flowchart illustrating an example of the flow of the operation accepting process according to the modification.

### DESCRIPTION OF REFERENCE CHARACTERS

1: mobile phone; 2: display side portion; 3: operation side portion; 6: side key; 10: codec portion; 11: speaker; 13: microphone; 14: operation keys; 15: LCD; 17: light emitting portion; 19: infrared communication portion; 21: control portion; 22: radio circuit; 24: camera; 25: acceleration sensor; 26: open/close switch; 27: vibration portion; 28: card I/F; 28A: flash memory; 31: ROM; 32: RAM; 33: EEPROM; 51: acceleration detecting portion; 53: process selecting portion; 55: candidate determination portion; 57: data type selecting portion; 59: process executing portion; 61: open/close detecting portion; 63: light emission control portion; 65: list displaying portion; 67: flashing portion; 69: selection displaying portion; 71: candidate color displaying portion; 73: history storing portion; 75: association portion; 81: color table; 83: history information; 101: LED; and 103: light guide plate.

### BEST MODES FOR CARRYING OUT THE INVENTION

Embodiments of the present invention will now be described with reference to the drawings. In the following description, like reference characters denote like parts, which have like names and functions, and therefore, detailed description thereof will not be repeated.

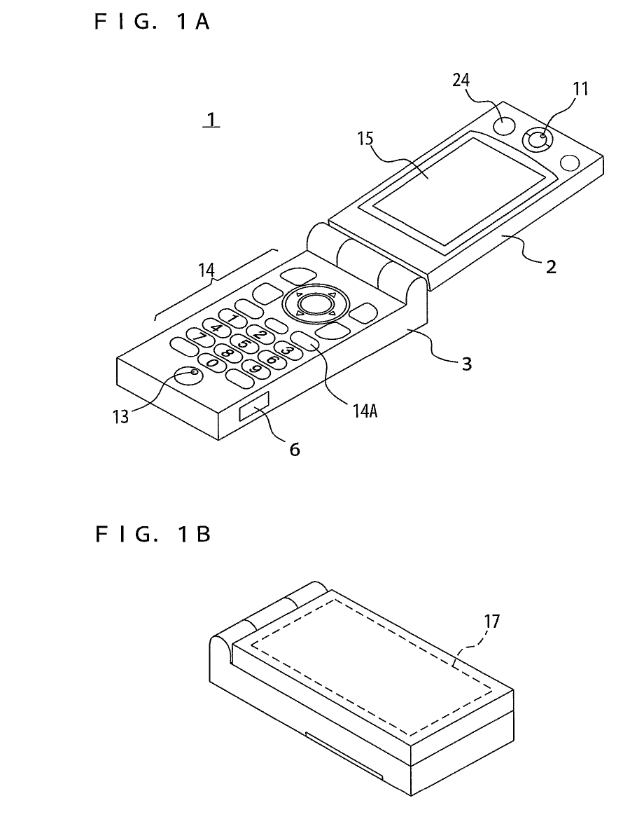

FIG. 1 shows, in perspective views, a mobile phone according to an embodiment of the present invention. FIG. 1A is a perspective view of the mobile phone in an open style, while FIG. 1B is a perspective view of the mobile phone in a closed style. Referring to FIGS. 1A and 1B, a mobile phone 1 includes an operation side portion 3 and a display side portion 2. Operation side portion 3 has operation keys 14, including a power key 14A, ten keys, and a talk key, and a microphone 13 arranged on its inner surface, and a side key 6 arranged on its side. Display side portion 2 has a liquid crystal display (LCD) 15, a speaker 11 constituting a receiver, and a camera 24 arranged on its inner surface, and a light emitting portion 17 arranged on its outer surface. Although mobile phone 1 has LCD 15 in this example, LCD 15 may be replaced with an organic electro-luminescence (EL) display.

Operation side portion 3 and display side portion 2 are rotatably connected via a hinge mechanism to be freely opened and closed. The state where mobile phone 1 is folded and operation side portion 3 and display side portion 2 are in the closed position corresponds to the closed style of mobile phone 1, whereas the state where mobile phone 1 is open and operation side portion 3 and display side portion 2 are in the open position corresponds to the open style of mobile phone 1. When mobile phone 1 is in the closed state, the display surface of LCD 15 faces operation side portion 3, so that the display surface cannot be visually identified from the outside. On the other hand, light emitting portion 17 is arranged opposite to the display surface of LCD 15, so that the light emitted from light emitting portion 17 can be visually identified from the outside.

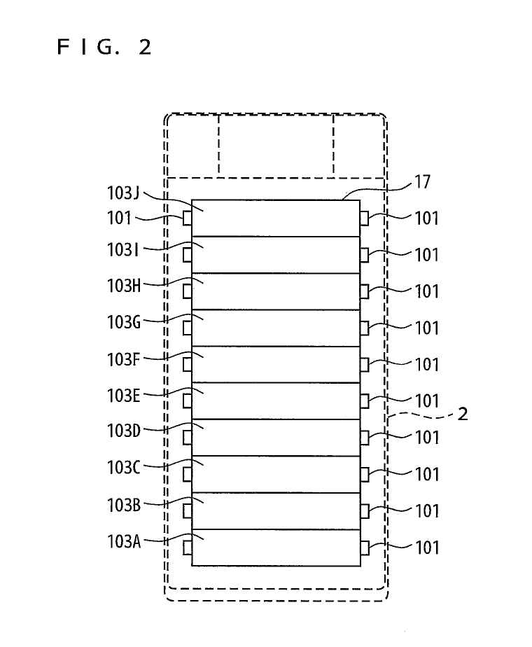

FIG. 2 is a plan view of the light emitting portion. Referring to FIG. 2, light emitting portion 17 includes ten light guide plates 103 arranged in the longitudinal direction of display side portion 2 of mobile phone 1, and a pair of color LEDs 101 arranged on respective sides of each of ten light guide plates 103. With a set of one light guide plate 103 and a pair of color LCDs 101, light emitted from each color LCD 101 is reflected by light guide plate 103 to the outside. As a result, the entire light guide plate 103 emits light in one color. With ten such sets of one light guide plate 103 and a pair of color LCDs 101, ten light guide plates 103 can each emit light in a certain color independent from each other. This allows ten light guide plates 103 to emit light in different colors from each other or in a same color.

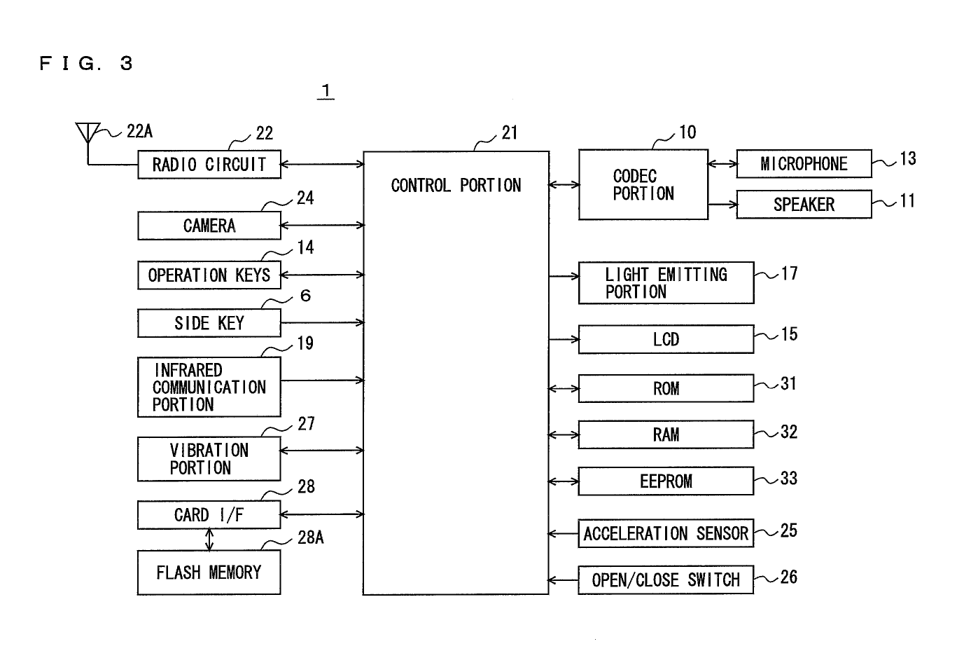

FIG. 3 is a functional block diagram showing an example of the functions of the mobile phone according to the present embodiment. Referring to FIG. 3, mobile phone 1 includes: a control portion 21 which is responsible for overall control of mobile phone 1; a radio circuit 22 connected to an antenna 22A; a codec portion 10 for processing audio data; microphone 13 and speaker 11 each connected to codec portion 10; camera 24; operation keys 14 and side key 6 for accepting an input of a user's operation; an infrared communication portion 19; a vibration portion 27; a card interface (I/F) 28; light emitting portion 17; LCD 15; a read only memory (ROM) 31 for storing, among others, a program to be executed by control portion 21; a random access memory (RAM) 32 used as a work area for control portion 21; an electronically erasable and programmable ROM (EEPROM) 33 which stores data in a nonvolatile manner; an acceleration sensor 25; and an open/close switch 26.

Radio circuit 22 performs radio communication with a base station apparatus connected to a communication network. A radio signal transmitted from the base station apparatus is received by antenna 22A. Radio circuit 22 receives a radio signal received by antenna 22A, and outputs an audio signal obtained by demodulating the radio signal to codec portion 10. Further, radio circuit 22 receives an audio signal from codec portion 10, and outputs a radio signal obtained by modulating the audio signal to antenna 22A. The radio signal transmitted from antenna 22A is received by the base station apparatus.

Codec portion 10 decodes an audio signal input from radio circuit 22, converts the decoded digital audio signal to an analog signal, and amplifies the signal to output it to speaker 11. Further, codec portion 10 receives an analog audio signal from microphone 13, converts the audio signal to a digital signal, encodes it, and outputs the encoded audio signal to radio circuit 22.

Card I/F 28 is mounted with a removable flash memory 28A. Control portion 21 is capable of accessing flash memory 28A via card I/F 28. While it is here assumed that the program to be executed by control portion 21 is stored in ROM 31, the program may be stored in flash memory 28A and read therefrom to be executed by control portion 21. The recording medium for storing the program is not restricted to flash memory 28A. It may be a flexible disk, a cassette tape, an optical disk (compact disc-ROM (CD-ROM), magnetic optical disc (MO), mini disc (MD), digital versatile disc (DVD)), an IC card, an optical card, or a semiconductor memory such as a mask ROM, an erasable programmable ROM (EPROM), an EEPROM, or the like. Still alternatively, mobile phone 1 may be connected to the Internet via radio circuit 22 and the program may be downloaded from a computer connected to the Internet, to be executed by control portion 21. As used herein, the “program” includes, not only the program directly executable by control portion 21, but also a source program, a compressed program, an encrypted program, and others.

Camera 24 is provided with a lens and a photoelectric conversion element such as a complementary metal oxide semiconductor (CMOS) sensor. The lens collects light and focuses it onto the CMOS sensor, which in turn performs photoelectric conversion of the received light to output image data to control portion 21. Camera 24 is controlled by control portion 21. Camera 24 starts picking up an image in accordance with an instruction from control portion 21, and outputs the obtained still image data or moving image data to control portion 21. Camera 24 includes an image processing circuit which performs image processing for improving image quality of the image data, and an A/D converting circuit for converting analog image data to digital image data. Control portion 21 displays on LCD 15 the still image data or the moving image data output from camera 24. Alternatively, control portion 21 encodes the still image data or the moving image data using a compression coding method, and stores the encoded data in EEPROM 34 or flash memory 28A mounted to card I/F 28.

Infrared communication portion 19 transmits and receives data through infrared radiation as a medium. For example, it transmits data to and receives data from an external device in accordance with the infrared data association (IrDA) standard. It is noted that although data is transmitted and received through infrared radiation as a medium in this example, the mobile phone may communicate with an external device in a wireless communication manner using electromagnetic waves. Further, instead of or in addition to infrared communication portion 19, a serial interface or a parallel interface may be provided, which may be connected to an external device through a communication cable to transmit data to and receive data from the external device.

Acceleration sensor 25 detects acceleration, and outputs the detected acceleration to control portion 21. Acceleration sensor 25 may detect the acceleration in one direction or in a plurality of directions. Control portion 21, on the basis of the acceleration input from acceleration sensor 25, detects an operation of shaking mobile phone 1.

Open/close switch 26 detects opening/closing of mobile phone 1. Open/close switch 26 is ON when mobile phone 1 is in the closed state, and OFF when mobile phone 1 is not in the closed state. Control portion 21 detects the state of open/close switch 26 so as to detect whether mobile phone 1 is in the closed state or an open state. It is here assumed that mobile phone 1 is in the open state when it is not in the closed state.

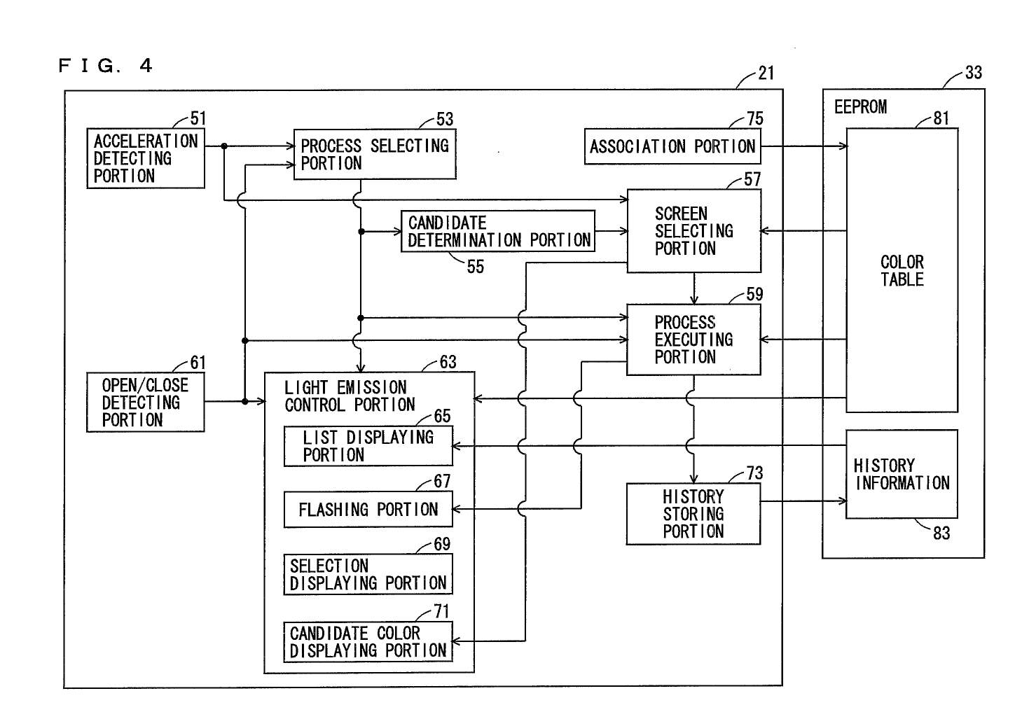

FIG. 4 is a functional block diagram schematically showing the functions of the control portion, together with data stored in the EEPROM. Referring to FIG. 4, control portion 21 includes: an acceleration detecting portion 51 connected to acceleration sensor 25; an open/close detecting portion 61 connected to open/close switch 26; a process selecting portion 53 which selects a process to be executed; a light emission control portion 63 which controls light emitting portion 17; a candidate determination portion 55 which determines a candidate of a process to be executed; a screen selecting portion 57 which selects a type of data to be processed; a process executing portion 59 which executes a process; a history storing portion 73 for storing a history of processes that have been executed; an association portion 75 which associates a respective one of a plurality of processes with one of a plurality of colors; and a history storing portion 73 which stores history information indicating that process executing portion 59 has executed a process.

Process executing portion 59 executes a plurality of types of processes. Here, the plurality of types of processes include: an e-mail process, an outgoing/incoming call process, a Web page browsing process, and an alarm process. The e-mail process includes a process of transmitting an e-mail, a process of receiving an e-mail, a process of editing an e-mail, and a process of viewing a received e-mail. Process executing portion 59 outputs process identification information for identifying a process that has been executed, to history storing portion 73. Further, when one of conditions predetermined for the plurality of processes is satisfied, process executing portion 59 outputs to light emission control portion 63 the process identification information for identifying the process for which the condition has been satisfied. The predetermined conditions are stored in advance in the form of a condition table in EEPROM 33.

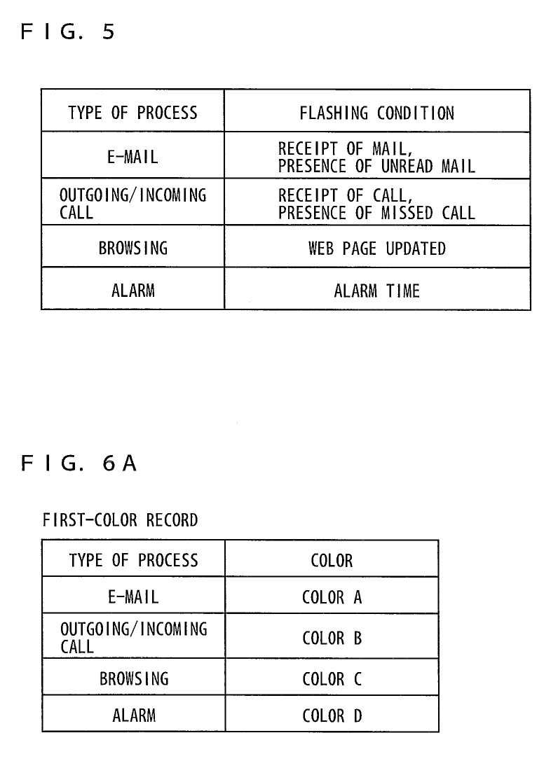

FIG. 5 shows an example of a condition table. Referring to FIG. 5, the condition table associates a flashing condition with each type of process. The flashing condition requires a change in data to be processed. Specifically, for the e-mail process, the receipt of an e-mail or the presence of an unread e-mail is associated as the flashing condition. In other words, the flashing condition requires that a newly arrived e-mail exists as new data. For the outgoing/incoming call process, an incoming call or the presence of a history of missed call as new data is associated as the flashing condition. For the browsing process, the update of a Web page which has been registered as a favorite is associated as the flashing condition. In other words, when a Web page is updated, the updated Web page becomes new data. For the alarm process, the fact that the time as a process target matches the alarm time is associated as the flashing condition.

Returning to FIG. 4, history storing portion 73 stores a history of processes which have been executed by process executing portion 59. Specifically, history storing portion 73 generates a history record, including process identification information of the process that has been executed and date and time at which the process was executed, and adds the record to history information 83, which is stored in EEPROM 33, for storage. History storing portion 73 updates history information 83 on a daily basis. Specifically, history storing portion 73 stores in RAM 32 the history records of the processes that have been executed by process executing portion 59 before an update, and at a predetermined time, it updates history information 83 with the history records stored in RAM 32 up to then. Further, history storing portion 73 keeps the history records in history information 83 for a predetermined period, which may be a week, a month, or any other arbitrary period. With the history records kept for a predetermined period, the frequencies of processes executed by process executing portion 59 during the predetermined period can be calculated, allowing recent trends to be analyzed with reference to the current time.

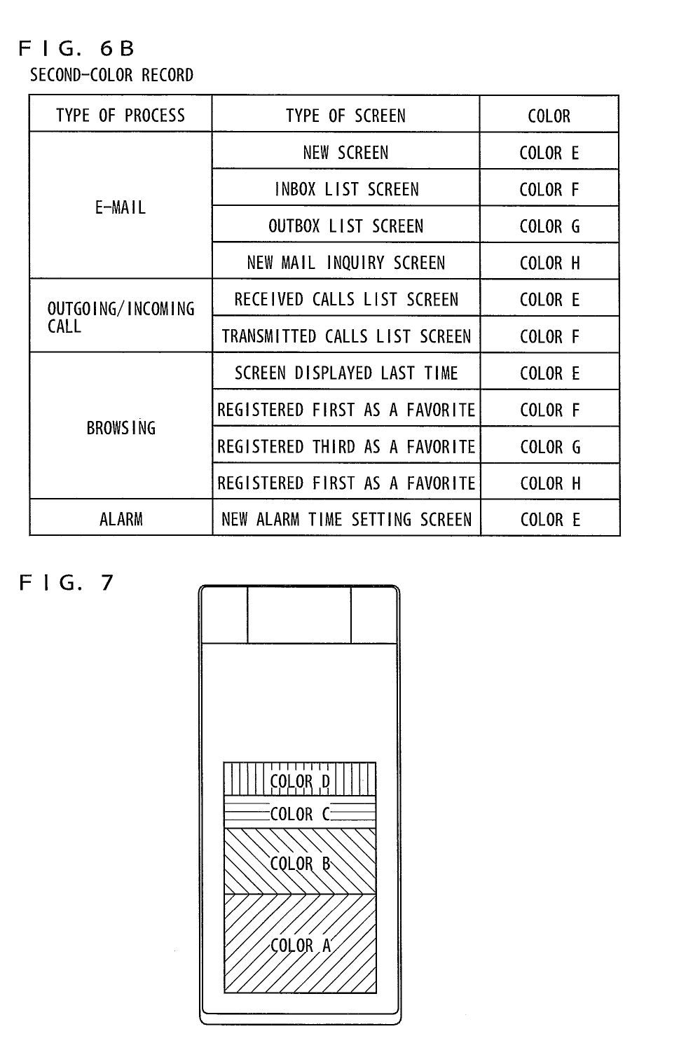

FIG. 6A shows an example of a first-color record in a color table. Referring to FIG. 6A, in the first-color record, a plurality of types of processes which can be executed by process executing portion 59, i.e. the e-mail process, the outgoing/incoming call process, the browsing process, and the alarm process, are each associated with one of a plurality of colors. Specifically, the e-mail process is associated with color A, the outgoing/incoming call process is associated with color B, the browsing process is associated with color C, and the alarm process is associated with color D. For the purposes of helping a user to remember the types of the processes and the colors associated therewith, it is preferable that when a certain process is to be executed, at least part of an operation screen, such as a background thereof, displayed on LCD 15 is set to the color associated with that process. This allows the user to determine the type of the process intuitively from the color the user sees when operating.

FIG. 6B shows an example of a second-color record in a color table. Referring to FIG. 6B, in the second-color record, a plurality of types of screens which can be displayed for a plurality of types of processes, i.e. the e-mail process, the outgoing/incoming call process, the browsing process, and the alarm process in this example, are each associated with one of a plurality of colors. Specifically, of the screens which can be displayed with execution of the e-mail process, a “new screen” for use in creating a new e-mail is associated with color E, an “inbox list screen” for listing e-mails received is associated with color F, an “outbox list screen” for listing e-mails transmitted is associated with color G, and a “new mail inquiry screen” for use in inquiring an e-mail server for newly received electronic data is associated with color H.

Further, of the screens which can be displayed with execution of the outgoing/incoming call process, a “received calls list screen” for listing phone numbers of incoming calls is associated with color E, and a “transmitted calls list screen” for listing phone numbers of outgoing calls is associated with color F.

Of the screens which can be displayed by the browsing process, a “screen displayed last time” is associated with color E, a “screen registered first as a favorite” is associated with color F, a “screen registered second as a favorite” is associated with color G, and a “screen registered third as a favorite” is associated with color H.

Of the screens which can be displayed by the alarm process, a “new alarm time setting screen” for use in setting an alarm time is associated with color E.

For the purposes of helping a user to remember the screens displayed and the colors associated therewith, it is preferable that when a certain screen is to be displayed on LCD 15, part of the display portion, such as a background or characters, is set to the color associated with that screen. This allows the user to determine the type of the data intuitively from the color the user sees when operating.

Returning to FIG. 4, acceleration detecting portion 51 determines whether an operation of shaking mobile phone 1 has been input, on the basis of the acceleration input from acceleration sensor 25. When a user shakes mobile phone 1, acceleration sensor 25 detects acceleration. When mobile phone 1 is shaken once, acceleration is generated in the direction in which mobile phone 1 moves. Subsequently, acceleration is generated, when mobile phone 1 is stopped, in the direction opposite to the movement direction of mobile phone 1. Thus, when acceleration in one direction is detected and then acceleration in the opposite direction is detected, acceleration detecting portion 51 detects that mobile phone 1 has been shaken once, and accepts the shaking operation. When detecting that mobile phone 1 has been shaken once, acceleration detecting portion 51 accepts the shaking operation and outputs a signal, indicating that the shaking operation has been input, to process selecting portion 53 and screen selecting portion 57. It is here assumed that the direction of acceleration detected by acceleration sensor 25 is parallel to the plane containing the direction in which light guide plates 103A to 103J in light emitting portion 17 are arranged.

Open/close detecting portion 61 detects the state of open/close switch 26 so as to detect the state of mobile phone 1. When open/close switch 26 is ON, open/close detecting portion 61 detects that mobile phone 1 is in the closed state.

When open/close switch 26 is OFF, it detects that mobile phone 1 is in the open state. Open/close detecting portion 61 outputs the detected state of mobile phone 1 to process selecting portion 53, light emission control portion 63, and process executing portion 59.

Light emission control portion 63 includes: a list displaying portion 65 for displaying a list of a plurality of types of processes to be executed; a flashing portion 67 for displaying a process requiring urgent attention in a flashing mode; a selection displaying portion 69 for displaying a process selected; and a candidate color displaying portion 71.

When a signal indicating that the shaking operation has been input is input from acceleration detecting portion 51 while the closed state is being detected by open/close detecting portion 61, list displaying portion 65 refers to the first-color data in the color table to determine a plurality of colors which correspond respectively to the plurality of types of processes which can be executed by process executing portion 59, and causes light emitting portion 17 to emit light in the plurality of colors which were determined. The light emission state in which light emitting portion 17 emits light under the control of list displaying portion 65 is called a “list displaying state”. List displaying portion 65 refers to history information 83 so as to emit light in a wider area for a process which has been executed frequently. It may be configured such that the light emitting area is increased with a process executed more frequently. While list displaying portion 65 controls light emitting portion 17 to be in the list displaying state, list displaying portion 65 outputs to process selecting portion 53 a signal indicating the list displaying state and, for each of a plurality of types of processes, a set of its process identification information and its frequency.

FIG. 7 shows an example of a list displaying state of the light emitting portion. The list displaying state of light emitting portion 17 shown in FIG. 7 corresponds to the state where light guide plates 103A, 103B, and 103C in light emitting portion 17 are emitting light in color A, light guide plates 103D and 103E are emitting light in color B, light guide plate 103F is emitting light in color C, and light guide plate 103G is emitting light in color D. It is noted that different hatchings in the figure represent different colors, and that the characters indicated in the figure for the sake of convenience of indicating colors do not actually exist. In the first-color record in the color table shown in FIG. 6A, colors A, B, C, and D are associated with the e-mail process, outgoing/incoming call process, browsing process, and alarm process, respectively. Thus, it can be seen from the list displaying state shown in FIG. 6 that the e-mail process has been performed most frequently. It can also be seen that the outgoing/incoming call process has been performed with the second greatest frequency, and that the browsing process and the alarm process have been performed less frequently.

Returning to FIG. 4, when flashing portion 67 receives process identification information from process executing portion 59 in the state where list displaying portion 65 causes light emitting portion 17 to emit light in the list displaying state, flashing portion 67 controls light emitting portion 17 to flash the light of the color that is associated by the first-color record in color table 81 stored in EEPROM 33 with the process specified by that process identification information. In the case where there is a process that satisfies a flashing condition, or, when there is a process in which the data as a processing target has changed, process executing portion 59 outputs the process identification information for that process. Accordingly, the user can be notified of the event that the data to be processed in the process associated with the color of the flashing light among those illuminated in the list displaying state has been changed. In other words, the user can be notified of the process that has new data to be processed and thus requires urgent attention. Flashing portion 67 outputs to process selecting portion 53 the process identification information for the process that is associated with the color of the light in flashing mode.

It is noted that, in the state where list displaying portion 65 causes light emitting portion 17 to emit light in the list displaying state, flashing portion 67 may refer to history information 83 to acquire the process identification information of the process that has been executed lastly, and control light emitting portion 17 to flash the light of the color that is associated by the first-color record in color table 81 stored in EEPROM 33 with the lastly executed process specified by that process identification information. This can notify the user of the fact that the process associated with the color of the flashing light among those illuminated in the list displaying state is the process that has been executed lastly.

In the state where a signal indicating the list displaying state is input from list displaying portion 65, when a signal indicating that a shaking operation has been input is received from acceleration detecting portion 51, with side key 6 being untouched, then process selecting portion 53 selects one of a plurality of processes. Process selecting portion 53 selects the plurality of processes one by one in turn every time the shaking operation is input from acceleration detecting portion 51. Process selecting portion 53 outputs the process identification information for the selected process to light emission control portion 63, candidate determination portion 55, and process executing portion 59.

The order in which the plurality of types of processes are to be selected is determined as follows. In the case where process identification information is input from flashing portion 67, the process specified by that process identification information is selected. This allows the process requiring urgent attention to be selected first. Subsequently, on the basis of the sets of process identification information and frequencies of the respective processes which are input from list displaying portion 65, the processes specified by the process identification information are selected in descending order of their frequencies. When light emitting portion 17 is in the list displaying state shown in FIG. 7, process selecting portion 53 selects the processes in the order of the e-mail process associated with color A, the outgoing/incoming call process associated with color B, the browsing process associated with color C, and the alarm process associated with color D. In the case where the process identification information is input from flashing portion 67, the process specified by that process identification information is selected first, and thus, the order of selecting the processes is updated such that each process is selected only once. For example, in the case where there is a missed call, the outgoing/incoming call process is selected first, and subsequently, the e-mail process with the highest frequency is selected secondly. As the outgoing/incoming call process with the second highest frequency has already been selected, the browsing process with the next highest frequency is selected third, and then, the alarm process is selected fourthly.

When side key 6 is pressed, candidate determination portion 55 determines the process specified by the process identification information that has been input from process selecting portion 53 at that time as a candidate process. Candidate determination portion 55 then outputs the process identification information of the determined candidate process to screen selecting portion 57.

When a signal indicating that a shaking operation has been input is received from acceleration detecting portion 51 in the state where side key 6 is being pressed, screen selecting portion 57 refers to the second-color record in color table 81 stored in EEPROM 33 to select one of a plurality of types of screens that can be displayed by the process specified by the process identification information input from candidate determination portion 55. The order of selecting the screens may be determined in advance. Then, screen selecting portion 57 outputs the color associated with the selected screen by the second-color record to light emission control portion 63. Further, screen selecting portion 57 outputs the process identification information input from candidate determination portion 55 and screen identification information for identifying the selected screen to process executing portion 59.

Here, a specific example will be described with reference to the second-color record shown in FIG. 6B. In the case where the process identification information input from candidate determination portion 55 specifies the e-mail process, when a signal indicating that a shaking operation has been input is received from acceleration detecting portion 51, the “new screen” is selected, and color E is output to candidate color displaying portion 71. Next, when another signal indicating that the shaking operation has been input is received from acceleration detecting portion 51, the “inbox list screen” is selected, and color F is output to candidate color displaying portion 71. Next, when still another signal indicating that the shaking operation has been input is received from acceleration detecting portion 51, the “outbox list screen” is selected, and color G is output to candidate color displaying portion 71. Further, when yet another signal indicating that the shaking operation has been input is received from acceleration detecting portion 51, the “new mail inquiry screen” is selected, and color H is output to candidate color displaying portion 71.

When the process identification information is input from process selecting portion 53, selection displaying portion 69 included in light emission control portion 63 refers to the first-color data in the color table to determine the color that is associated with the process specified by that process identification information, and causes a predetermined first position in light emitting portion 17, which is a part corresponding to the lowermost light guide plate 103A in this example, to be illuminated in the determined color.

Candidate color displaying portion 71, upon receipt of the color from screen selecting portion 57, causes a predetermined second position in light emitting portion 17, which is a part corresponding to the uppermost light guide plate 103J in this example, to be illuminated in the received color. The light emission state in which light emitting portion 17 emits light under the control of list displaying portion 65 and candidate color displaying portion 71 is called a “selection displaying state”.

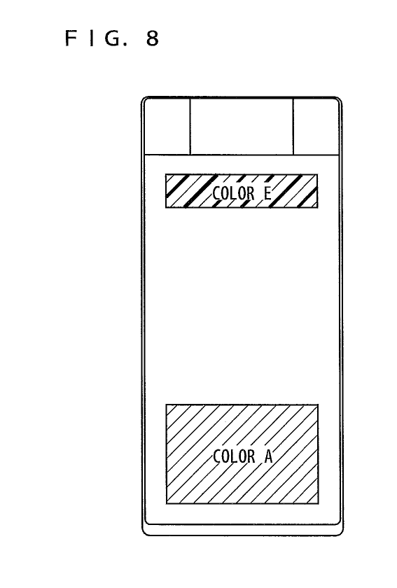

FIG. 8 shows an example of a selection displaying state of the light emitting portion. The selection displaying state of light emitting portion 17 shown in FIG. 8 corresponds to the state where light guide plates 103A, 103B, and 103C in light emitting portion 17 are emitting light in color A and light guide plate 103J is emitting light in color E. It is noted that different hatchings in the figure represent different colors, and that the characters indicated in the figure for the sake of convenience of indicating colors do not actually exist. In the first-color record in the color table shown in FIG. 6A, color A is associated with the e-mail process, and in the second-color record in the color table shown in FIG. 6B, color E is associated with the “new screen”. Accordingly, it can be seen from this selection displaying state that the e-mail process has been selected as a candidate process and the “new screen” has been selected.

In the state where nothing has been input from screen selecting portion 57 and the process identification information has been input from process selecting portion 53, when the state of mobile phone 1 received from open/close detecting portion 61 changes from the closed state to the open state, then process executing portion 59 executes the process that is specified by the process identification information input from process selecting portion 53. In this case, the operation screen displayed on LCD 15 is the operation screen that is predetermined for the process specified by the process identification information input from process selecting portion 53.

In the case where the process specified by the process identification information input from process selecting portion 53 satisfies a flashing condition, process executing portion 59 displays a screen for displaying the data satisfying the condition. For example, in the case where the process specified by the process identification information input from process selecting portion 53 is the e-mail process and there is an unread e-mail, the “inbox list screen” is displayed so as to notify of the presence of the unread e-mail. In the case where the process specified by the process identification information input from process selecting portion 53 is the outgoing/incoming call process and there is a missed call, the “received calls list screen” is displayed so as to notify of the phone number of the missed call. In the case where the process specified by the process identification information input from process selecting portion 53 is the browsing process and when the Web page corresponding to the “screen registered first as a favorite” is updated, the “screen registered first as a favorite” is displayed so as to display the updated Web page. In the case where the process specified by the process identification information input from process selecting portion 53 is the alarm process and when the current time coincides with the alarm time or the alarm time has passed, an alarm screen notifying of the alarm time is displayed.

In the state where the process identification information and the screen identification information are input from screen selecting portion 57, when the state of mobile phone 1 input from open/close detecting portion 61 changes from the closed state to the open state, then process executing portion 59 executes the process that is specified by the process identification information input from screen selecting portion 57. In this case, the screen displayed on LCD 15 is the screen that is specified by the screen identification information input from screen selecting portion 57. For example, in the case where the process specified by the process identification information input from screen selecting portion 57 is the e-mail process and the screen identification information input therefrom indicates the “new screen”, the “new screen” is displayed. In the case where the process specified by the process identification information input from screen selecting portion 57 is the outgoing/incoming call process and the screen identification information input therefrom indicates the “received calls list screen”, the “received calls list screen” is displayed. Further, in the case where the process specified by the process identification information input from screen selecting portion 57 is the browsing process and the type of data is “registered first as a favorite”, a browsing screen for displaying the Web page of the URL registered first as a favorite is displayed.

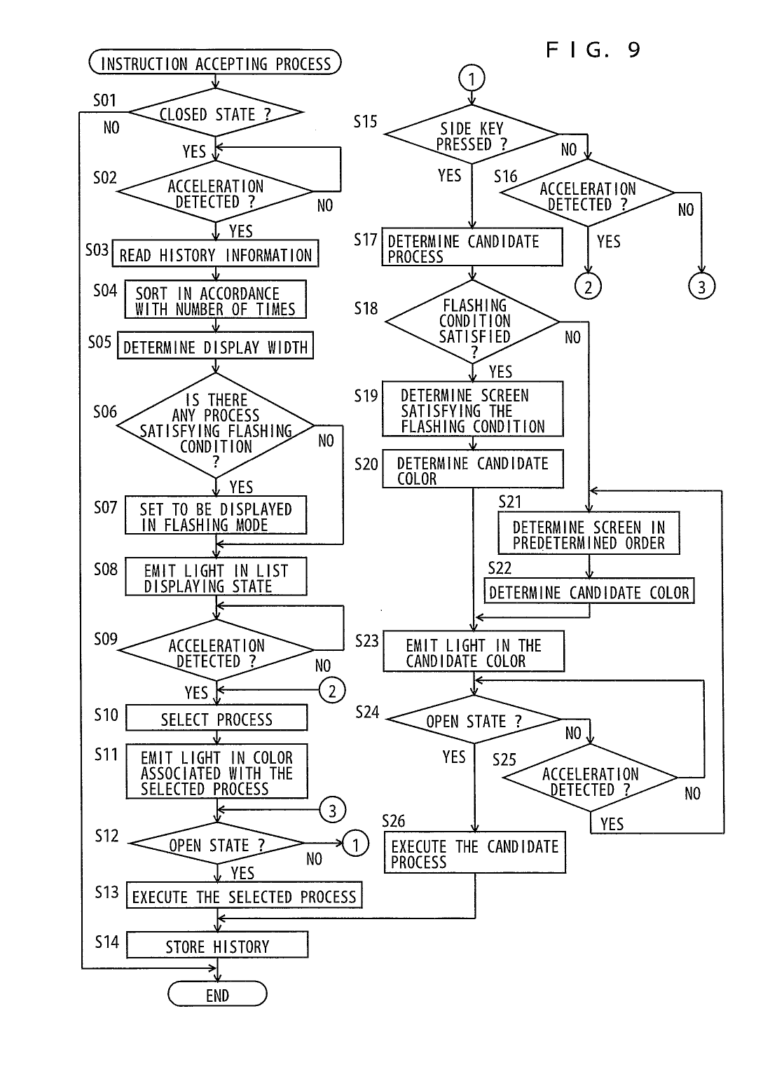

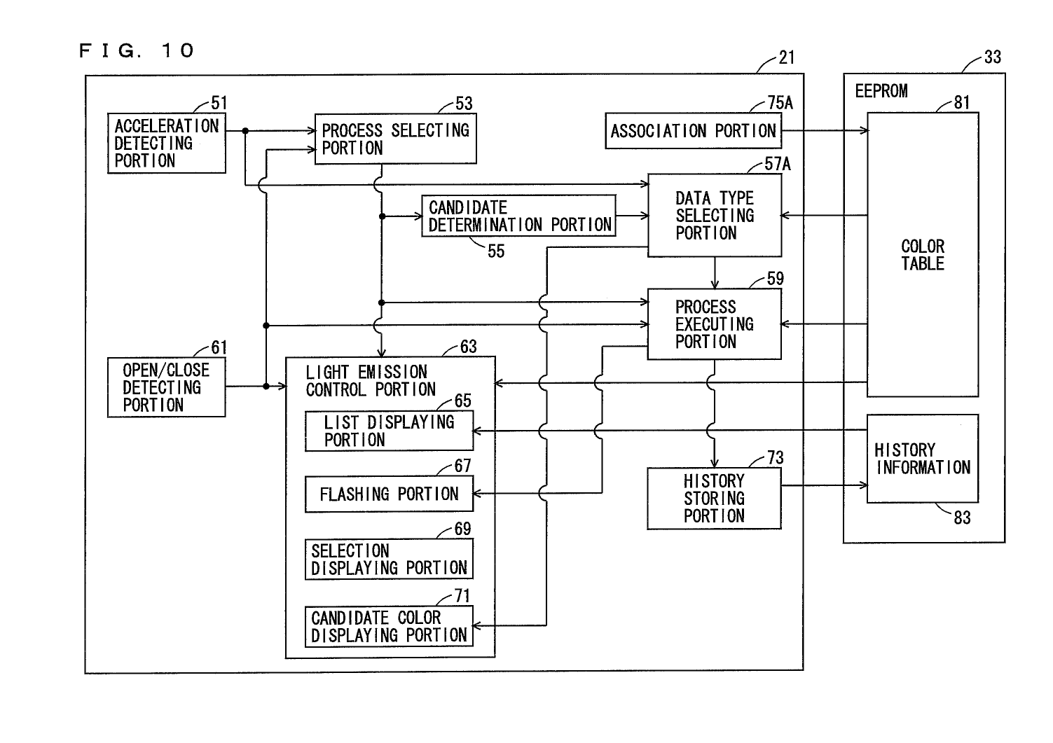

FIG. 9 is a flowchart illustrating an example of the flow of an operation accepting process. The operation accepting process is carried out by control portion 21 as control portion 21 executes an operation accepting program. Referring to FIG. 9, control portion 21 determines whether mobile phone 1 is in the closed state (step S01). If the state of the open/close switch is ON, indicating that mobile phone 1 is in the closed state, the process proceeds to step S02. If the state of the open/close switch is OFF, indicating that mobile phone 1 is in the open state, the process is terminated. That is, the operation accepting process is a process which is executed on the condition that mobile phone 1 is in the closed state.

In step S02, it is determined whether acceleration has been detected by acceleration sensor 25. The process is placed in a wait state until acceleration is detected (NO in step S02), and once acceleration is detected, it is determined that a shaking operation has been input, and the process proceeds to step S03.

In step S03, history information 83 stored in EEPROM 33 is read out. Then, history information 83 is analyzed so as to sort the processes according to the number of executions thereof (step S04). Specifically, for the history records included in history information 83, the number of history records with the same process identification information is counted, and the pieces of process identification information are sorted in descending order of the count values.

In step S05, a display width is determined. The process that has been executed in a greater number of times is assigned a greater display width. Here, the display width is determined in accordance with ten light guide plates 103A to 103J included in light emitting portion 17. At least one of light guide plates 103A to 103J is assigned to a respective one of the plurality of pieces of process identification information. It is here assumed that the e-mail process has been executed more frequently than the outgoing/incoming call process, which in turn has been executed more frequently than the browsing process, and the browsing process and the alarm process have been executed the equal number of times. In this case, three light guide plates 103A to 103C are assigned to the e-mail process, two light guide plates 103D and 103E are assigned to the outgoing/incoming e-mail process, one light guide plate 103F is assigned to the browsing process, and one light guide plate 103G is assigned to the alarm process.

In step S06, it is determined whether there is a process that satisfies a flashing condition. If there is any process satisfying the flashing condition, the process proceeds to step S07; otherwise, the process proceeds to step S08, with step S07 being skipped. In step S07, the process satisfying the flashing condition is set to be displayed in a flashing mode. Specifically, at least one light guide plate that has been assigned in step S05 to that process satisfying the flashing condition is caused to flash on and off. In step S08, light emitting portion 17 is caused to emit light in the list displaying state. For the part that has been set to be displayed in a flashing mode in step S07, the corresponding LEDs 101 are caused to flash on and off.

In step S09, it is determined whether acceleration has been detected by acceleration sensor 25. The process is placed in a wait state until acceleration is detected (NO in step S09), and once acceleration is detected, it is determined that a shaking operation has been input, and the process proceeds to step S10.

In step S10, one of the e-mail process, outgoing/incoming call process, browsing process, and alarm process is selected in the order as follows. Firstly, in the case where it is determined in step S06 that there is a process which satisfies a flashing condition, the process satisfying the flashing condition is selected. If there is more than one process satisfying the flashing condition, or if there is no process satisfying the flashing condition, the processes are selected in descending order of the number of executions thereof. The process selected in step S10 is called the “selected process”.

In step S11, light emitting portion 17 is caused to emit light in the color associated with the selected process. The part to be illuminated may be predetermined. For example, the part corresponding to light guide plate 103A may be illuminated.

Next, it is determined whether mobile phone 1 is in the open state (step S12). If the state of the open/close switch is OFF, indicating that mobile phone 1 is in the open state, the process proceeds to step S13. If the state of the open/close switch is ON, indicating that mobile phone 1 is in the closed state, the process proceeds to step S15.

In step S13, the selected process is executed. In this case, an operation screen predetermined for the selected process is displayed on LCD 15. In the following step S14, a history indicating that the process has been executed is stored, before the process is finished. Specifically, a history record including the process identification information for the executed process and the date and time when the process was executed is generated, and is added to history information 83, which is stored in EEPROM 33, for storage.

On the other hand, in step S15, it is determined whether side key 6 has been pressed. If the side key has been pressed, the process proceeds to step S17; otherwise, the process proceeds to step S16. In step S16, it is determined whether acceleration has been detected by acceleration sensor 25. If acceleration has been detected, it is determined that a shaking operation has been input, and the process returns to step S10.

If acceleration is not detected, the process returns to step S12. That is, when the shaking operation is input with side key 6 being untouched, the next process in order is selected. When mobile phone 1 is opened with side key 6 being untouched and no shaking operation being input, the selected process is executed.

In step S17, the process selected in step S10 is determined as a candidate process. It is then determined whether the candidate process satisfies a flashing condition (step S18). If the candidate process satisfies the flashing condition, the process proceeds to step S19; otherwise, the process proceeds to step S21. In step S19, a screen for displaying the data satisfying the flashing condition is determined. Then, the color that is associated in the second-color record in the color table with the screen identification information for that screen determined in step S19 is determined as a candidate color (step S20), and the process proceeds to step S23.

On the other hand, in step S21, a screen is selected in a predetermined order. Then, the color that is associated in the second-color record in the color table with that screen selected is determined as a candidate color (step S22), and the process proceeds to step S23.

In step S23, light emitting portion 17 is caused to emit light in the color that has been determined as the candidate color in step S20 or step S22. The part to be illuminated may be predetermined. For example, the part corresponding to light guide plate 103J may be illuminated.

In step S24, it is determined whether mobile phone 1 has attained an open state, as in step S12. If mobile phone 1 is in the open state, the process proceeds to step S26. If mobile phone 1 is in the closed state, the process proceeds to step S25.

In step S25, it is determined whether acceleration has been detected by acceleration sensor 25. If acceleration has been detected, it is determined that a shaking operation has been input, and the process returns to step S21. If acceleration is not detected, the process returns to step S24. That is, when a shaking operation is input after side key 6 has been pressed, the next screen in order is selected. When mobile phone 1 is opened after side key 6 has been pressed, the candidate process is executed.

In step S26, the process that has been determined as the candidate process in step S17 is executed. In this case, the candidate process is executed for displaying the screen determined in step S19 or step S21 among a plurality of types of screens. The process then proceeds to step S14. In step S14, a history indicating that the candidate process has been executed is stored. Specifically, a history record including the process identification information for the candidate process and the date and time when the process was executed is generated, and the record is added to history information 83, which is stored in EEPROM 33, for storage.

As described above, according to mobile phone 1 of the present embodiment, color table 81 is stored in EEPROM 33, which includes the first-color record in which a respective one of a plurality of types of processes is associated with one of a plurality of colors. When a shaking operation is accepted in the closed state, one of the plurality of types of processes is selected, and light emitting portion 17 is caused to emit light in the color that is associated with that selected process. This allows the selected process to be notified with the color in the closed state. When a change from the closed state to the open state is detected, the selected process is executed. This enables the process selected in the closed state to be executed with a simple operation of changing the state of mobile phone 1.

Further, history information 83 which indicates that respective ones of a plurality of types of processes have been executed is stored in EEPROM 33. On the basis of this history information 83, the processes are selected in descending order of the number of executions thereof. This can reduce the number of operations required.

Furthermore, before a process is selected, a plurality of parts corresponding respectively to the plurality of types of processes are illuminated in the colors associated with the respective types of processes. The plurality of parts each have an area that is determined in accordance with the number of times the corresponding process has been executed. This can notify the user of the order in the number of executions of the respective types of processes.

In the case where there is new data to be processed in one of the plurality of types of processes, the light of the color associated with that process is flashed on and off, which can notify the user of the presence of the new data to be processed.

Furthermore, one of the plurality of types of processes can be selected in the closed state, and one of a plurality of types of screens that can be displayed by that selected process can also be selected, thereby enabling operations in the closed state.

<Modification>

In the embodiment described above, for each of a plurality of types of processes, a respective one of a plurality of types of screens that can be displayed thereby is associated with one of a plurality of colors. In contrast, in mobile phone 1 according to a modification, for each of the plurality of types of processes, a respective one of a plurality of types of data to be processed thereby is associated with one of a plurality of colors. In the following, differences from the above-described mobile phone 1 will primarily be described.

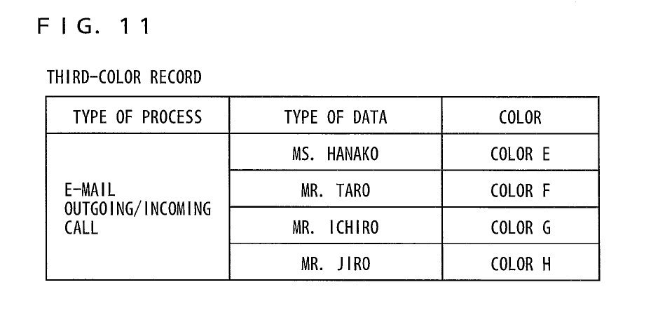

FIG. 10 is a functional block diagram showing an example of the functions of the control portion included in mobile phone 1 according to the modification. This differs from the functional block diagram shown in FIG. 4 in that association portion 75A has been modified, and that screen selecting portion 57 has been replaced with a data type selecting portion 57A. The other functions are similar to those in the above-described embodiment, and thus, description thereof will not be repeated here.

Association portion 75A, in accordance with an input of a user through operation keys 14, generates a first-color record in which a respective one of a plurality of types of processes is associated with a corresponding color, and adds the first-color record into color table 81, which is stored in EEPROM 33, for storage. Furthermore, association portion 75 associates a respective one of a plurality of types of data to be processed in each of the plurality of types of processes with one of a plurality of colors. Association portion 75, in accordance with an operation input by a user through operation keys 14, generates a third-color record in which a respective one of a plurality of types of data is associated with a corresponding color, and adds the third-color record into color table 81, stored in EEPROM 33, for storage.

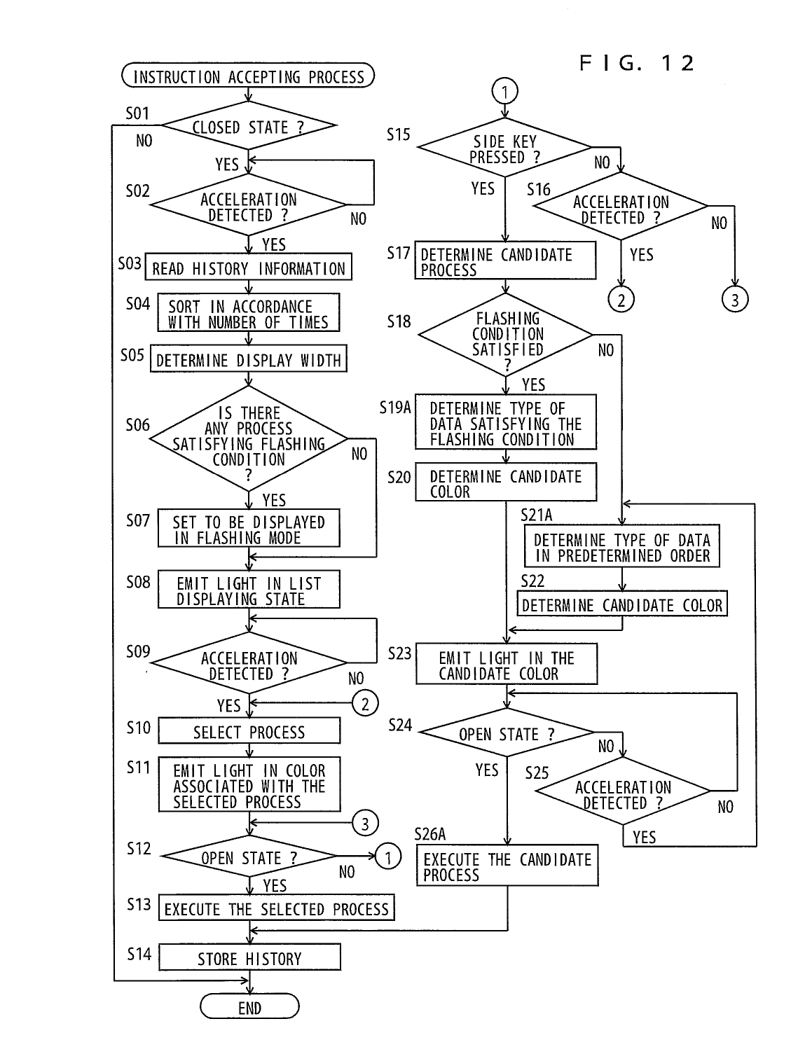

FIG. 11 shows an example of a third-color record according to the modification. Referring to FIG. 11, in the third-color record of the modification, a plurality of types of data to be processed in a plurality of types of processes, i.e. the email process and the outgoing/incoming call process in this example, are each associated with one of a plurality of colors. Specifically, data related to “Ms. Hanako” to be processed in the e-mail process and the outgoing/incoming call process is associated with color E, data related to “Mr. Taro” is associated with color F, data related to “Mr. Ichiro” is associated with color G, and data related to “Mr. Jiro” is associated with color H. The data to be processed in the e-mail process includes emails transmitted and received. Among them, the data related to “Ms. Hanako”, for example, includes an e-mail having the e-mail address of “Ms. Hanako” set as its destination or source address. The data to be processed in the outgoing/incoming call process includes histories of outgoing and incoming calls. Among them, the data related to “Ms. Hanako”, for example, includes a history of an outgoing or incoming call having the phone number of “Ms. Hanako” set as its originator or receiver.

For the purposes of helping a user to remember the types of the data and the colors associated therewith, it is preferable that when data is displayed on LCD 15, part of a display portion, such as a background or characters, is set to the color associated with that type of the data. This allows the user to determine the type of the data intuitively from the color the user sees when operating.

Returning to FIG. 10, in the case where the process identification information input from candidate determination portion 55 specifies a predetermined process, when a signal indicating that a shaking operation has been input is received from acceleration detecting portion 51 while side key 6 is being pressed, then data type selecting portion 57A refers to the third-color record in color table 81 stored in EEPROM 33 to select one of the plurality of types of data that are to be processed by the process specified by the process identification information input from candidate determination portion 55. The predetermined process in this example includes the email process and the outgoing/incoming call process. The order of selecting the types of data may be determined in advance, or the types of data may be selected in descending order of the number of records included in each of the types of data. Then, data type selecting portion 57A outputs the color that is associated with the selected type of data by the third-color record, to light emission control portion 63. Further, data type selecting portion 57A outputs the process identification information input from candidate determination portion 55 as well as the selected type of data, to process executing portion 59.

A specific example will now be described with reference to the third-color record shown in FIG. 11. In the case where the process identification information input from candidate determination portion 55 specifies the e-mail process or the outgoing/incoming call process, when a signal indicating that a shaking operation has been input is received from acceleration detecting portion 51, the type of data “Ms. Hanako” is selected, and color E is output to candidate color displaying portion 71. Next, when another signal indicating that a shaking operation has been input is received from acceleration detecting portion 51, the type of data “Mr. Taro” is selected, and color F is output to candidate color displaying portion 71. Next, when still another signal indicating that a shaking operation has been input is received from acceleration detecting portion 51, the type of data “Mr. Ichiro” is selected, and color G is output to candidate color displaying portion 71. Thereafter, when yet another signal indicating that a shaking operation has been input is received from acceleration detecting portion 51, the type of data “Mr. Jiro” is selected, and color H is output to candidate color displaying portion 71.

When the process identification information is input from process selecting portion 53, selection displaying portion 69 included in light emission control portion 63 refers to the first-color data in the color table to determine the color that is associated with the process specified by that process identification information, and causes a predetermined first position in light emitting portion 17, which is the part corresponding to the lowermost light guide plate 103A in this example, to be illuminated in the determined color.

When the color is input from data type selecting portion 57A, candidate color displaying portion 71 causes a predetermined second position in light emitting portion 17, which is the part corresponding to the uppermost light guide plate 103J in this example, to be illuminated in the input color.

For example, it is here assumed that light emitting portion 17 is in the selection displaying state shown in FIG. 8, where light guide plates 103A, 103B, and 103C in light emitting portion 17 are emitting light in color A and light guide plate 103J is emitting light in color E. In the first-color record in the color table shown in FIG. 6A, color A is associated with the e-mail process, and in the third-color record in the color table shown in FIG. 11, color E is associated with the data type “Ms. Hanako”. Accordingly, it can be seen from the selection displaying state shown in FIG. 8 that the e-mail process has been selected as the candidate process and “Ms. Hanako” has been selected as the data type.

In the state where the process identification information for a predetermined process and the type of data are input from data type selecting portion 57A, when the state of mobile phone 1 input from open/close detecting portion 61 changes from the closed state to the open state, process executing portion 59 executes the process that is specified by the process identification information input from data type selecting portion 57A. In this case, the operation screen displayed on LCD 15 is the screen for displaying the data that is specified by the type of data input from data type selecting portion 57A. For example, in the case where the process specified by the process identification information input from data type selecting portion 57A is the e-mail process and the type of data is “Ms. Hanako”, then a browsing screen for displaying a received e-mail having the e-mail address of “Ms. Hanako” set as its originator address, or a transmitted e-mail having the e-mail address of “Ms. Hanako” set as its destination address, is displayed. In the case where the process specified by the process identification information input from data type selecting portion 57A is the outgoing/incoming call process and the type of data is “Ms. Hanako”, then a browsing screen for displaying the phone number of “Ms. Hanako” included in the incoming call history, or the phone number of “Ms. Hanako” included in the outgoing call history, is displayed.

FIG. 12 is a flowchart illustrating an example of the flow of the operation accepting process according to the modification. This differs from the operation accepting process shown in FIG. 9 in that steps S19A, S21A, and 26A have been modified. The other processes are identical, and thus, description thereof will not be repeated here.

In step S19, the type of data that satisfies the flashing condition is determined. Then, the color that is associated with that type of data determined in step S19 in the third-color record in the color table is determined as a candidate color (step S20), and the process proceeds to step S23.

On the other hand, in step S21, the type of data is determined in a predetermined order. Then, the color that is associated with the determined type of data in the third-color record in the color table is determined as a candidate color (step S22), and the process proceeds to step S23.

In step S26, the process that has been determined as the candidate process in step S17 is executed for the type of data that has been determined in step S19 or S21, and the process proceeds to step S14.

According to mobile phone 1 of the modification, one of a plurality of types of processes can be selected in the closed state, and one of a plurality of types of data to be processed in that selected process can also be selected, thereby enabling operations in the closed state.

While mobile phone 1 has been described as an example of the mobile device in the above embodiment, it is needless to say that the invention may be understood as an operation accepting method for causing mobile phone 1 to perform the processing shown in FIG. 9 or 12, or as an operation accepting program for causing a computer to perform the operation accepting method.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

1. A mobile device changeable in state between an open state and a closed state, comprising:
a light emitting portion to emit light in a plurality of colors toward the outside in the closed state;
an association portion to associate a respective one of a plurality of types of processes with one of said plurality of colors;
an operation accepting portion to accept a predetermined operation;
a process selecting portion to select one of said plurality of types of processes in response to an event that said predetermined operation is accepted;
a light emission control portion to cause said light emitting portion to emit light in the color that is associated with said selected process in the closed state; and
a process executing portion to execute said selected process in response to an event that a change from the closed state to the open state is detected.

2. The mobile device according to claim 1, further comprising a history storing portion to store history information indicating that respective ones of said plurality of types of processes have been executed, wherein
said process selecting portion selects one of said plurality of types of processes in descending order of the number of executions thereof, on the basis of said history information.

3. The mobile device according to claim 2, wherein
before a process is selected by said process selecting portion, said light emission control portion causes each of a plurality of parts corresponding respectively to said plurality of types of processes to be illuminated in the color associated with the corresponding type of process, and
each of said plurality of parts has an area that is determined in accordance with the number of times the corresponding type of process has been executed.

4. The mobile device according to claim 3, wherein in the case where there is new data to be processed in any of said plurality of types of processes, said light emission control portion causes light of the color associated with that process to be flashed on and off.

5. The mobile device according to claim 3, wherein said light emission control portion causes light of the color associated with one of said plurality of types of processes that was executed lastly to be flashed on and off.

6. The mobile device according to claim 1, further comprising a history storing portion to store history information indicating that respective ones of said plurality of types of processes have been executed, wherein
before a process is selected by said process selecting portion, said light emission control portion causes each of a plurality of parts corresponding respectively to said plurality of types of processes to be illuminated in the color associated with the corresponding type of process, and
each of said plurality of parts has an area that is determined in accordance with the number of times the corresponding type of process has been executed.

7. The mobile device according to claim 6, wherein in the case where there is new data to be processed in any of said plurality of types of processes, said light emission control portion causes light of the color associated with that process to be flashed on and off.

8. The mobile device according to claim 6, wherein said light emission control portion causes light of the color associated with one of said plurality of types of processes that was executed lastly to be flashed on and off.

9. The mobile device according to claim 1, wherein said association portion further associates, for each of said plurality of types of processes, a respective one of a plurality of types of screens that can be displayed by execution of the corresponding type of process with one of a plurality of colors,
the mobile device further comprising:
a candidate determination portion to determine said selected process as a candidate; and
a candidate color selecting portion, in response to an event that said predetermined operation is accepted after said candidate has been determined, to select as a candidate color one of the plurality of colors associated respectively with the plurality of types of screens that can be displayed by execution of the process determined as said candidate; wherein
said light emission control portion, in response to the event that said predetermined operation is accepted after said candidate has been determined, causes the color that is associated with the process determined as said candidate and the candidate color to be displayed, and
said process executing portion, in response to the event that a change from the closed state to the open state is detected, executes the process determined as said candidate, and displays the screen of the type associated with said candidate color.

10. The mobile device according to claim 1, wherein said association portion further associates, for each of said plurality of types of processes, a respective one of a plurality of types of data that are to be processed in the corresponding type of process with one of a plurality of colors,
the mobile device further comprising:
a candidate determination portion to determine said selected process as a candidate; and
a candidate color selecting portion, in response to an event that said predetermined operation is accepted after said candidate has been determined, to select as a candidate color one of the plurality of colors associated respectively with the plurality of types of data that are to be processed by the process determined as said candidate; wherein
said light emission control portion, in response to the event that said predetermined operation is accepted after said candidate has been determined, causes the color that is associated with the process determined as said candidate and the candidate color to be displayed, and
said process executing portion, in response to the event that a change from the closed state to the open state is detected, executes the process determined as said candidate, on the data of the type associated with said candidate color.

11. The mobile device according to claim 1, wherein when said process executing portion displays a screen by executing a process, said process executing portion displays at least a part of the screen in the color that is associated with that process.

12. The mobile device according to claim 1, wherein
said operation accepting portion includes an acceleration detecting portion to detect acceleration, and
said operation accepting portion accepts said predetermined operation in response to an event that the acceleration is detected.

13. An operation accepting method performed in a mobile device changeable in state between an open state and a closed state, said mobile device including a light emitting portion to emit light in a plurality of colors toward the outside in the closed state, the method comprising the steps of:
associating a respective one of a plurality of types of processes with one of said plurality of colors;
accepting a predetermined operation;
selecting one of said plurality of types of processes in response to an event that said predetermined operation is accepted;
causing said light emitting portion to emit light in the color that is associated with said selected process in the closed state; and
executing said selected process in response to an event that a change from the closed state to the open state is detected.

14. The operation accepting method according to claim 13, further comprising the step of storing history information indicating that respective ones of said plurality of types of processes have been executed, wherein
said process selecting step includes the step of selecting one of said plurality of types of processes in descending order of the number of executions thereof, on the basis of said history information.

15. The operation accepting method according to claim 14, wherein
said step of causing said light emitting portion to emit light includes the step of, before a process is selected in said process selecting step, causing each of a plurality of parts corresponding respectively to said plurality of types of processes to be illuminated in the color associated with the corresponding type of process, and
each of said plurality of parts has an area that is determined in accordance with the number of times the corresponding type of process has been executed.

16. The operation accepting method according to claim 15, wherein in the case where there is new data to be processed in any of said plurality of types of processes, said step of causing said light emitting portion to emit light includes the step of causing light of the color associated with that process to be flashed on and off.

17. The operation accepting method according to claim 15, wherein said step of causing said light emitting portion to emit light includes the step of causing light of the color associated with one of said plurality of types of processes that was executed lastly to be flashed on and off.

18. The operation accepting method according to claim 13, further comprising the step of storing history information indicating that respective ones of said plurality of types of processes have been executed, wherein
said step of causing said light emitting portion to emit light includes the step of, before a process is selected in said process selecting step, causing each of a plurality of parts corresponding respectively to said plurality of types of processes to be illuminated in the color associated with the corresponding type of process, and
each of said plurality of parts has an area that is determined in accordance with the number of times the corresponding type of process has been executed.

19. The operation accepting method according to claim 18, wherein in the case where there is new data to be processed in any of said plurality of types of processes, said step of causing said light emitting portion to emit light includes the step of causing light of the color associated with that process to be flashed on and off.

20. The operation accepting method according to claim 18, wherein said step of causing said light emitting portion to emit light includes the step of causing light of the color associated with one of said plurality of types of processes that was executed lastly to be flashed on and off.

21. The operation accepting method according to claim 13, wherein said associating step further includes the step of, for each of said plurality of types of processes, associating a respective one of a plurality of types of screens that can be displayed by execution of the corresponding type of process with one of a plurality of colors,
the operation accepting method further comprising the steps of:
determining said selected process as a candidate; and
in response to an event that said predetermined operation is accepted after said candidate has been determined, selecting as a candidate color one of the plurality of colors associated respectively with the plurality of types of screens that can be displayed by execution of the process determined as said candidate; wherein
said step of causing said light emitting portion to emit light includes the step of, in response to the event that said predetermined operation is accepted after said candidate has been determined, causing the color that is associated with the process determined as said candidate and the candidate color to be displayed, and
said process executing step includes the steps of
executing the process determined as said candidate in response to the event that a change from the closed state to the open state is detected, and
displaying the screen of the type associated with said candidate color.

22. The operation accepting method according to claim 13, wherein said associating step further includes the step of, for each of said plurality of types of processes, associating a respective one of a plurality of types of data that are to be processed in the corresponding type of process with one of a plurality of colors,
the operation accepting method further comprising the steps of:
determining said selected process as a candidate; and
in response to an event that said predetermined operation is accepted after said candidate has been determined, selecting as a candidate color one of the plurality of colors associated respectively with the plurality of types of data that are to be processed by the process determined as said candidate; wherein
said step of causing said light emitting portion to emit light includes the step of, in response to the event that said predetermined operation is accepted after said candidate has been determined, causing the color that is associated with the process determined as said candidate and the candidate color to be displayed, and
said process executing step includes the step of, in response to the event that a change from the closed state to the open state is detected, executing the process determined as said candidate, on the data of the type associated with said candidate color.

23. The operation accepting method according to claim 13, wherein said process executing step includes the step of, when displaying a screen by executing a process, displaying at least a part of the screen in the color that is associated with that process.

24. The operation accepting method according to claim 13, wherein
said operation accepting step includes the steps of
detecting acceleration, and
accepting said predetermined operation in response to an event that the acceleration is detected.
